(19) United States
(12) Patent Application Publication
(10) Pub. No.: US 2012/0155303 A1
(43) Pub. Date: Jun. 21, 2012

(54) METHOD AND APPARATUS FOR AVOIDING IN-DEVICE COEXISTENCE INTERFERENCE IN A WIRELESS COMMUNICATION SYSTEM

(76) Inventor: Richard Lee-Chee Kuo, Taipei (TW)

(21) Appl. No.: 13/314,681

(22) Filed: Dec. 8, 2011

Related U.S. Application Data
(60) Provisional application No. 61/423,972, filed on Dec. 16, 2010.

(51) Int. Cl. H04B 15/00; H04W 24/00; H04J 3/00

(52) U.S. Cl. 370/252

(57) ABSTRACT

A method and apparatus for coexistence interference avoidance in a UE equipped with a LTE radio and an ISM radio includes applying a TDM solution in the UE for avoiding coexistence interference between the LTE radio and the ISM radio, the TDM solution defining a period of the TDM solution allocated for the LTE radio and another period of TDM solution allocated for the ISM radio. The method further includes the UE reporting an ISM buffer status to an eNB for adapting the TDM solution.

### CROSS-REFERENCE TO RELATED APPLICATIONS

The present Application claims the benefit of U.S. Provisional Patent Application Ser. No. 61/423,972, filed on Dec. 16, 2010, the entire disclosure of which is incorporated herein by reference.

### FIELD

This disclosure generally relates to wireless communication networks, and more particularly, to a method and apparatus for avoiding in-device coexistence interference in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

According to one aspect, a method for coexistence interference avoidance in a user equipment (UE) equipped with an LTE radio and an industrial, scientific and medical (ISM) radio includes applying a time division multiplexing (TDM) solution in the UE for avoiding coexistence interference between the LTE radio and the ISM radio, the TDM solution defining a period allocated for the LTE radio and another period allocated for the ISM radio. The method further includes the UE reporting an ISM buffer status to an eNB for adapting the TDM solution.

According to another aspect, a communication device for use in a wireless communication system includes a LTE radio, an industrial, scientific and medical (ISM) radio, a control circuit coupled to the LTE radio and the ISM radio, a processor installed in the control circuit, and a memory installed in the control circuit and coupled to the processor. The processor is configured to execute a program code stored in memory to perform a coexistence interference avoidance in the communication device by applying a time division multiplexing (TDM) solution in the communication device for avoiding coexistence interference between the LTE radio and the ISM radio, the TDM solution defining a period allocated for the LTE radio and another period allocated for the ISM radio, and the communication device reporting an ISM buffer status to an eNB for adapting the TDM solution.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3.

FIG. 5 is a diagram of an exemplary Time Division Multiplexing (TDM) pattern.

FIG. 6 is a message flow diagram according to one embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA 3GPP LTE (Long Term Evolution) wireless access. 3GPP LTE-A (Long Term Evolution Advanced). 3GPP2 UMB (Ultra Mobile Broadband). WiMax, or some other modulation techniques.

In particular, The exemplary wireless communication systems devices described below may be designed to support one or more standards such as the standard offered by a consortium named “3rd Generation Partnership Project” referred to herein as 3GPP, including Document Nos. 3GPP TR 36.816 v1.0.0 (2010-11) “Study on signaling and procedure for interference avoidance for in-device coexistence (Release 10)”, and R2-106399, “Potential mechanism to realize TDM pattern”. The standards and documents listed above are hereby expressly incorporated herein.

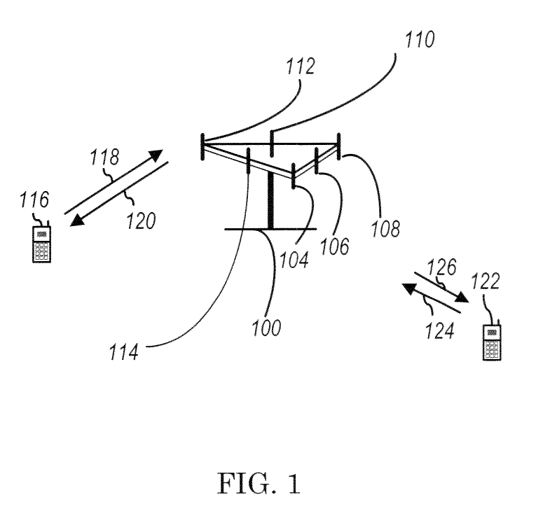

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

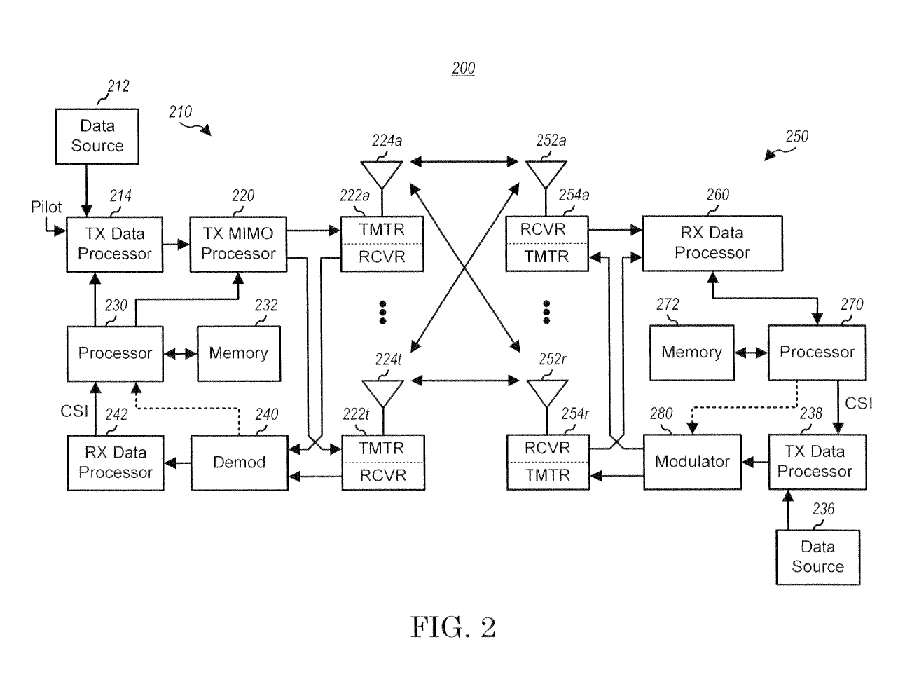

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM), TX MIMO processor 220 then provides N_{T} modulation symbol streams to N_{T} transmitters (TMTR) 222a through 222t. In certain embodiments. TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g. filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

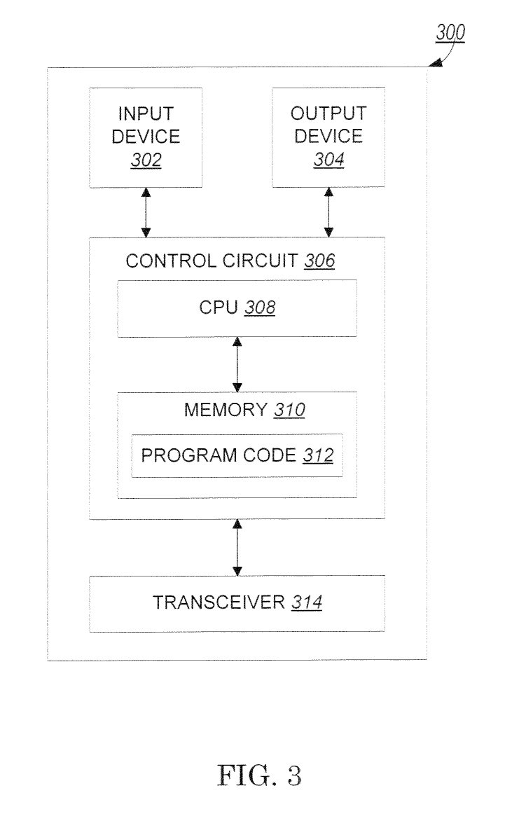

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

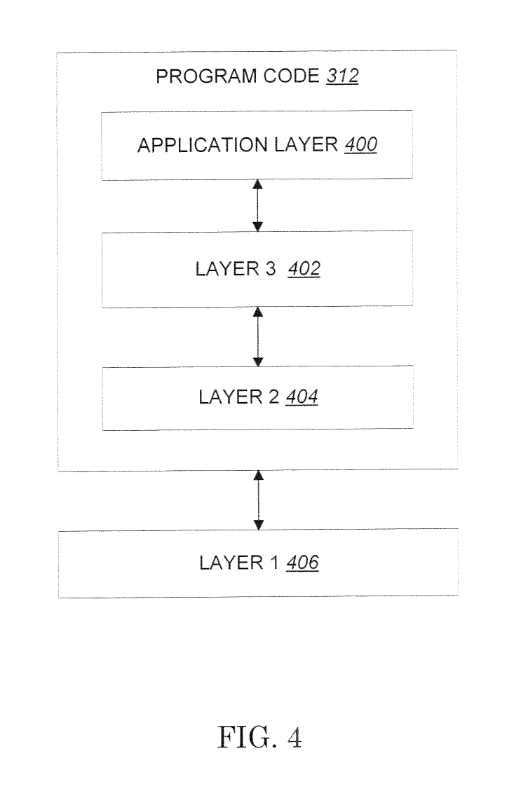

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

In order to allow users to access various networks and services ubiquitously, an increasing number of UEs are equipped with multiple radio transceivers. For example, a UE may be equipped with LTE, WiFi, Bluetooth transceivers, and Global Navigation Satellite System (GNSS) receivers. Transmissions from each of these radio transceivers may interfere with the reception by another one of these transceivers. Thus, these radio transceivers may interfere with each other's operations. 3GPP TR 36.816 v.1.0.0 (2010-11) addresses the issue of coexistence interference between multiple different radio transceivers in a UE. For example, 2.4 GHz industrial, scientific and medical (ISM) band is currently allocated for WiFi and Bluetooth channels, and 3GPP frequency bands around 2.4 GHz ISM band includes Band 40 for time division duplex (TDD) Mode and Band 7 UL for frequency division duplex (MD) mode. Thus, the transceiver that operates with the ISM band and the transceiver that operates with the 3GPP frequency band may interfere with each other.

3GPP TR 36.816 V1.0.0 (2010-11) also addresses potential solutions for resolving the noted interference issue, which are Frequency Division Multiplexing (FDM) solution and Time Division Multiplexing (TDM) solution. The potential TDM solutions according to 3GPP TR 36.816 v1.0.0 (2010-11) are a TDM solution without UE suggested patterns and a TDM solution with the UE suggested patterns. In the TDM solution without UE suggested patterns, the UE signals the necessary information, which is also referred to as assistant information. e.g. interferer type, mode and possibly the appropriate offset in subframes, to the eNB, based on Which the TDM patterns (scheduling period and/or the unscheduled period) are configured by the eNB. In the TDM solution without UE suggested patterns. UE suggests the patterns to the eNB, and it is up to the eNB to decide the final TDM patterns.

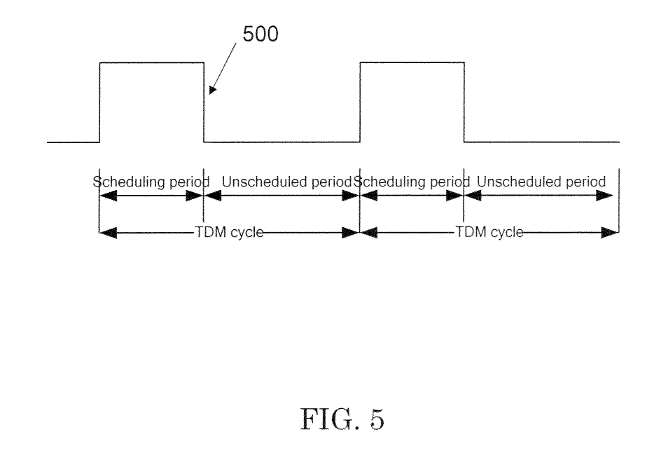

FIG. 5 shows a TDM cycle having a scheduling period and an unscheduled period. Scheduling period is a period in the TDM cycle during which the LTE UE may be scheduled to transmit or receive as shown by the TDM pattern 500. Unscheduled period is a period during which the LTE UE is not scheduled to transmit or receive as shown by the TDM pattern 500, thereby allowing the ISM radio to operate without interference. Table 1 summarizes exemplary pattern requirements for main usage scenarios:

TABLE 1

| | | Unscheduled |
|---|---|---|
| Usage scenarios | Scheduling period (ms) | period (ms) |
| LTE + BT earphone | Less than [60] ms | Around [15-60] ms |
| (Multimedia service) | | |
| LTE + WiFi portable | No more than | No more than [20-60] |
| router | [20-60] ms | ms |
| LTE + WiFi offload | No more than | No more than |
| | [40-100] ms | [40-100] ms |

R2-106399 proposed to adopt the Rel-8 discontinuous reception (DRX) mechanism as baseline for TDM solution. With the DRX mechanism as baseline, LTE uplink (UL) transmission and downlink (DL) reception may be performed during an Active Time and are not allowed during a sleeping time. Therefore, both uplink transmission and downlink reception are treated equally.

As discussed above, in the TDM solution without UE suggested patterns, the UE signals the assistant information, e.g. interferer type, mode and possibly the appropriate offset in subframes to the eNB, based on which the TDM patterns (scheduling period and/or the unscheduled period) are configured by the eNB. Although the operation mode of the interferer can, to a certain extent, reflect the traffic pattern over the ISM radio, the instant throughput depends on the radio link status. Accordingly, the initial TDM pattern may not be suitable for long term operation because the data over ISM radio may accumulate due to poor radio link status. Therefore, TDM pattern adaptation is necessary to reduce the ISM traffic latency.

To adapt the scheduling period and/or the unscheduled period of a TDM solution, a UE can directly send a signaling to request eNB to increase or decrease the scheduling period and/or the unscheduled period with certain amount of time based on the current ISM buffer status. However, both LTE and ISM traffics should be considered for determining the scheduling period and/or the unscheduled period. Additionally, the LTE DL traffic is unknown to the UE. Thus, eNB may decide not to change the scheduling period and/or the unscheduled period due to LTE DL traffic after reception of the request from UE. As a result, the UE may unnecessarily signal to change the scheduling period and/or the unscheduled period continuously.

According to embodiments of the disclosure as described in detail below, the UE can report the ISM buffer status so that eNB can adapt the scheduling period and/or the unscheduled period of a TDM solution accordingly.

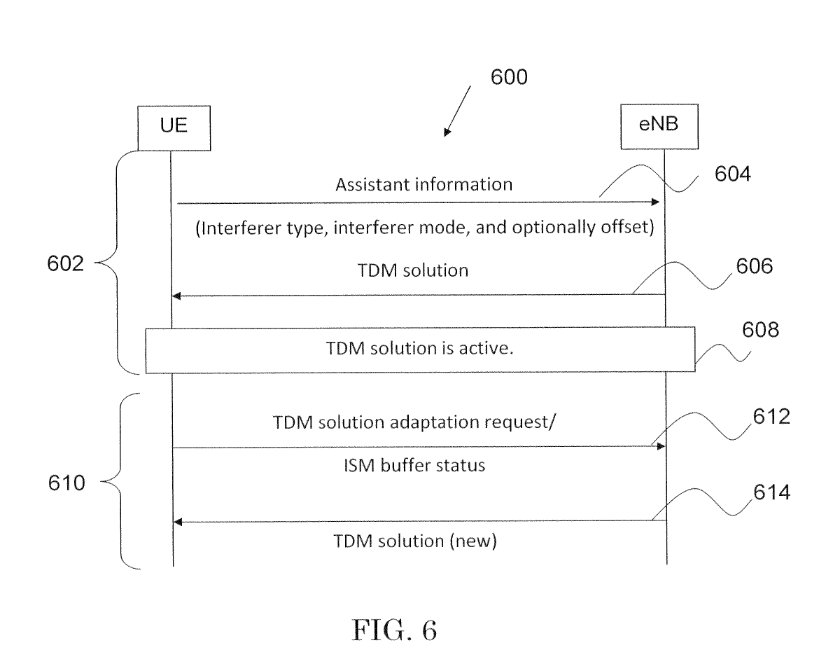

FIG. 6 shows a method 600 according to one embodiment for coexistence interference avoidance in a UE equipped with an LTE radio and an ISM radio. The method 600 includes at 602 applying a TDM solution in the UE for avoiding coexistence interference between the LTE radio and the ISM radio, the TDM solution defining a period allocated for the LTE radio and another period allocated for the ISM radio; and at 610, the UE reporting an ISM buffer status to an eNB for adapting the TDM solution.

The method 600 is now described in more detail. At 604, the UE signals assistant information, e.g. interferer type, mode and optionally the appropriate offset in subframes to eNB. The reason for the UE reporting the assistant information to the eNB may be for determining a TDM solution when the UE has a problem in ISM DL reception or in LTE DL reception. The eNB receives the information and based on the information configures the TDM patterns. The TDM patterns define the scheduling periods and the unscheduled periods. The LTE radio may be scheduled to transmit or receive during the period allocated for LTE radio, which may be called the scheduling period. The LTE radio may not be allowed to transmit or receive during the period allocated for ISM radio. The ISM radio may transmit or receive during the period allocated for ISM radio, which may be called the unscheduled period.

At 606, the TDM solution, i.e., the configured patterns, is transmitted to the LTE. At 608, the UE applies the TDM solution and the TDM solution is active. At 612, the UE sends a TDM solution adaptation request to the eNB, by which ISM buffer status is sent to the UE. The status, i.e., the ISM buffer status, may be reported periodically to the eNB. Alternatively, the status may be reported as a result of the ISM buffer size exceeding a predetermined buffer size threshold.

Upon receiving the ISM buffer status from the UE, the eNB can adapt the scheduling period and/or the unscheduled period of the TDM solution accordingly to configure a new TDM solution. The eNB then sends the new TDM solution to the UE at 614, which is applied to the UE. The TDM solution may include a TDM pattern configured to the UE by the eNB.

According to another embodiment, the TDM solution may be based on a discontinuous reception (DRX) mechanism, which includes an Active Time and a sleeping time. The Active time during which the UE monitors a physical downlink control channel (PDCCH) may correspond to the period allocated for the LTE radio. The sleeping time during which the UE does not monitor a PDCCH may correspond to the period allocated for ISM radio.

The disclosed method provides adapting period(s) of a TDM solution to reduce the ISM traffic latency. As discussed above, because the initial TDM pattern configured by the eNB may not be suitable for long term operation, a UE can directly send a signaling to request eNB to increase or decrease the scheduling period and/or the unscheduled period with certain amount of time based on the current ISM buffer status. However, because the LTE DL traffic is unknown to the UE, the eNB may decide not to change the scheduling period and/or the unscheduled period due to LTE DL traffic after reception of the request from UE, thereby causing the UE to unnecessarily signal to change the scheduling period and/or the unscheduled period continuously. According to the embodiments discussed herein, the UE reports the ISM buffer status to eNB so that the eNB can accordingly adapt the scheduling period and/or the unscheduled period of a TDM solution. Therefore, continuous signaling by the UE to the eNB to request scheduling period and/or the unscheduled period changes is avoided.

Referring back to FIGS. 3 and 4, the UE 300 includes a program code 312 stored in memory 310. The CPU 308 executes the program code 312 to a apply a TDM solution in the UE for avoiding coexistence interference between the LTE radio and the ISM radio, and the UE reporting an ISM buffer status to an eNB for adapting at least one of the periods of the TDM solution. The CPU 308 can also execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for coexistence interference avoidance in a user equipment (UE) equipped with an LTE radio and an industrial, scientific and medical (ISM) radio, the method comprising:
applying a time division multiplexing (TDM) solution in the UE for avoiding coexistence interference between the LTE radio and the ISM radio, the TDM solution defining a period allocated for the LTE radio and another period allocated for the ISM radio; and
the UE reporting an ISM buffer status to an eNB for adapting the TDM solution.

2. The method of claim 1, wherein the ISM buffer status is reported periodically.

3. The method of claim 1, wherein the ISM buffer status is reported when an ISM buffer size is larger than a buffer size threshold.

4. The method of claim 1, wherein the LTE radio is scheduled to transmit or receive during the period allocated for the LTE radio.

5. The method of claim 1, wherein the ISM radio is configured to transmit or receive during the period allocated for ISM radio.

6. The method of claim 1, wherein the LTE radio is not allowed to transmit or receive during the period allocated for ISM radio.

7. The method of claim 1, wherein the period allocated for the LTE radio defines a scheduling period.

8. The method of claim 1, wherein the period allocated for ISM radio defines an unscheduled period.

9. The method of claim 1, wherein a TDM pattern is configured to the UE by the eNB for the TDM solution.

10. The method of claim 1, wherein the TDM solution is based on a DRX mechanism comprising an Active Time and a sleeping time.

11. The method of claim 10, wherein the UE monitors a physical downlink control channel (PDCCH) during the Active Time, and wherein the Active Time corresponds to the period allocated for the LTE radio.

12. The method of claim 10, wherein the UE does not monitor a physical downlink control channel (PDCCH) during the sleeping time, and wherein the sleep time corresponds to the period allocated for the ISM radio.

13. The method of claim 1, further comprising reporting assistant information to the eNB for triggering the TDM solution when the UE has a problem in ISM downlink (DL) reception or in LTE DL reception.

14. The method of claim 13, wherein the assistant information comprises interferer type and interferer mode.

15. The method of claim 13, wherein the assistant information further comprises offset in subframes.

16. A communication device for use in a wireless communication system, the communication device comprising:
a LTE radio;
an industrial, scientific and medical (ISM) radio;
a control circuit coupled to the LTE radio and the ISM radio;
a processor installed in the control circuit;
a memory installed in the control circuit and coupled to the processor;
wherein the processor is configured to execute a program code stored in memory to perform a coexistence interference avoidance in the communication device by:
applying a time division multiplexing (TDM) solution in the communication device for avoiding coexistence interference between the LTE radio and the ISM radio, the TDM solution defining a period allocated for the LTE radio and another period allocated for the ISM radio; and
the communication device reporting an ISM buffer status to an eNB for adapting the TDM solution.

17. The device of claim 16, wherein the ISM buffer status is reported periodically.

18. The device of claim 16, wherein the ISM buffer status is reported when an ISM buffer size is larger than a buffer size threshold.

19. The device of claim 16, wherein the LTE radio is scheduled to transmit or receive during the period allocated for the LTE radio.

20. The device of claim 1, wherein the ISM radio is configured to transmit or receive during the period allocated for ISM radio.

21. The device of claim 16, wherein the LTE radio is not allowed to transmit or receive during the period allocated for ISM radio.

22. The device of claim 16, wherein the period allocated for the LTE radio defines a scheduling period.

23. The device of claim 16, wherein the period allocated for ISM radio defines an unscheduled period.

24. The device of claim 16, wherein a TDM pattern is configured to the UE by the eNB for the TDM solution.

25. The device of claim 16, wherein the TDM solution is based on a DRX mechanism comprising an Active Time and a sleeping time.

26. The device of claim 25, wherein the UE monitors a physical downlink control channel (PDCCH) during the Active Time, and wherein the Active Time corresponds to the period allocated for the LTE radio.

27. The device of claim 25, wherein the UE does not monitor a physical downlink control channel (PDCCH) during the sleeping time, and wherein the sleep time corresponds to the period allocated for the ISM radio.

28. The device of claim 16, further comprising reporting assistant information to the eNB for triggering the TDM solution when the UE has a problem in ISM downlink (DL) reception or in LTE DL reception.

29. The device of claim 28, wherein the assistant information comprises interferer type and interferer mode.

30. The device of claim 28, wherein the assistant information further comprises offset in subframes.
